(19) United States
(12) Patent Application Publication
(10) Pub. No.: US 2019/0281831 A1
(43) Pub. Date: Sep. 19, 2019

(54) FOAM CONTROL AGENT AND COMPOSITIONS THEREOF

(71) Applicant: Dow Global Technologies LLC, Midland, MI (US)

(72) Inventors: Ling Zhong, Shanghai (CN); Jianhai Mu, Shanghai (CN); Meijia He, Shanghai (CN)

(73) Assignee: Dow Global Technologies LLC, Midland, MI (US)

(21) Appl. No.: 16/303,339

(22) PCT Filed: May 27, 2016
(86) PCT No.: PCT/CN2016/083752

§ 371 Date: Nov. 20, 2018

(30) Foreign Application Priority Data
May 27, 2016 (CN) PCT/CN2016/083752

(51) Int. Cl. A01N 57/20; C08K 5/00; C08L 71/02; A01N 25/04

(52) U.S. Cl. CPC A01N 57/20; A01N 25/04; C08L 71/02; C08K 5/0058

(57) ABSTRACT

A polyether foam control agent including a butylene-containing polyether foam control agent useful for preparing an agrochemical formulation; a water-based agrochemical formulation containing a combination of (a) at least one butylene-containing polyether foam control agent described above, (b) at least one active ingredient, and (c) water, and a process for preparing the agrochemical formulation.

### FIELD

The present invention is related to a foam control agent and a composition containing the foam control agent, such as an agrochemical formulation.

### BACKGROUND

Pesticide active materials are formulated into either solid or concentrated liquid forms based on the physical and chemical properties of active ingredients. These formulations often need to be dispersed or diluted with water for spraying. A common problem in the dispersion and dilution process in which agitation is often involved is foaming. Foaming may result in difficulties in mixing and spraying, or even failure to achieve the desired dilution of the agrochemical. A low-foaming feature is very desirable for a pesticide formulation. Thus, minimizing the foaming of the pesticide formulation would be very beneficial in preparing an effective pesticide formulation.

Foam control agents are needed in most agrochemical formulations. Examples of known foam control agents include fatty acid, mineral oil and fatty alcohol, organosilicone, polyether and the like. Among the known foam control agents, organosilicone is often used both as “in-can” and “tank-mix” foam control agents to inhibit the development of foaming in agrochemical applications. Although it is well known that an organosilicone foam control agent has an acceptable efficiency for use in agrochemical formulations, it is also well-known that an organosilicone is very sensitive to formulation conditions (such as pH, temperature, solvent, and the like). For example, organosilicone tends to decompose and/or lose its defoaming effectiveness when used in a formulation having a pH of >7 or a pH of <5, and when used in combination with common polar solvents, such as methanol, dimethylformamide (DMF), N-methyl-2-pyrrolidone (NMP) and other solvents. In addition, an organosilicone foam control agent has problems with being soluble in both water and organic solvents. In some transparent formulation types, e.g. microemulsions (ME) and soluble liquids (SL), adding organosilicone foam to the formulation will result in a formulation that is turbid.

Moreover, the above-mentioned foam control agents have problems with being compatible in high electrolyte formulations such as formulations that contain pesticide active materials in their salt type form. Examples of such salt type pesticide active materials include glyphosate, paraquat, and glufosinate ammonium.

U.S. Pat. No. 8,357,823 B2 discloses alkylene oxide capped secondary alcohol ethoxylates as fermentation foam control agents. The above patent discloses an EO/BO composition as a fermentation foam control agent in a fermentation process.

### SUMMARY

One embodiment of the present invention is directed to a polyether foam control agent containing butylene oxide (BO) units useful for agro formulation applications. For example, the polyether foam control agent includes a mixture of polyethylene oxide (PO) units and BO units resulting in a polyether compound with PO/BO units; or the polyether foam control agent can include a mixture of ethylene oxide (EO) units and BO units resulting in a polyether foam control agent with EO/BO units. The foam control agent of the present invention is useful, for example, as an additive for agrochemical formulations.

Another embodiment of the present invention is directed to a water-based agrochemical formulation including a combination of: (a) the polyether foam control agent described above; (b) at least one pesticide active: and (c) water.

Other embodiments of the present invention include a process for preparing the polyether foam control agent; a process for preparing the water-based agrochemical formulation containing the polyether foam control agent; and a process for using the water-based agrochemical formulation.

The BO group-containing polyether of the present invention exhibits an effective foam control property/effect when used in a water-based agrochemical formulation. In addition, the BO group-containing polyether foam control agent of the present invention has good compatibility to strong electrolytes present in the water-based agrochemical formulation. During thermal storage, for example at room temperature or at a temperature 54° C. or more, the foam control agent of the present invention can maintain its foam control effectiveness.

### DETAILED DESCRIPTION

An “agrochemical formulation” herein means a pesticide formulation comprising at least one active ingredient and one or more other additives. The pesticide agrochemical formulation can be used, for example, to control grass, kill insects, and eliminate bacteria for crop protection applications.

“Low foaming” with reference to a foam control agent herein means a level of foaming performance that meets the required level established by the Food and Agriculture Organization (FAO) of the United Nations or better. The foam level of a formulation can be reduced by a certain percentage using the defoaming agent of the present invention, for example the foam level of a formulation can be reduced to less than 90 percent (%) in one embodiment, and to less than 50% in another embodiment, of the initial foam level value as measured by a “persistent foam volume” measurement method described in the Example section herein.

“Compatibility” herein means, with reference to a formulation that is formed by mixing formulation ingredients together, a measure of how stable an ingredient is when mixed with another ingredient, for example an ingredient's solubility in aqueous or solvent-based systems. If ingredients mix and do not change, the ingredients are considered compatible. If ingredients mix and change or do not mix at all, the ingredients are considered incompatible. Thus, the formulation herein is compatible when the formulation does not undergo an undesirable change in appearance after mixing the ingredients such as for example the formulation does not result in cloudiness, precipitation, flocculation, turbidity, or other visual quality issue as observed by the naked eye.

A “strong electrolyte” herein means, with reference to a formulation, the concentration of the electrolyte in solution is from about 0.1 weight percent (wt %) to about 40 wt % in one embodiment, and from about 20 wt % to about 30 wt % in another embodiment.

“Thermal storage” herein means storage at a temperature higher than room temperature (about 23° C.) such as for example a typical thermal test temperature of 54° C. or more.

“Defoaming efficiency ratio” herein means the ratio of foam volume of a formulation containing a foam control agent to foam volume of a formulation without a foam control agent (i.e., a blank test sample).

In general, the present invention is directed to providing a polyalkylene glycol (PAG) copolymer with BO units in the chemical structure of the PAG copolymer. More specifically, a polyether containing BO units is prepared to form a polyether foam control agent. For example, in one embodiment, the BO-containing polyether of the present invention useful as a foam control agent (also interchangeably referred to as a “defoamer” or “defoaming agent”) can be described by the following chemical formula designated as Structure (I):

R₁[O-(AO)ₐ-(BO)_{b}-R₂]_{c} Structure (I)

wherein R₁ can be an alkyl backbone remnant from an alkyl alcohol initiator; AO can be a alkylene oxide remnant, such as a propylene oxide or ethylene oxide remnant, after copolymerization; BO can be a 1,2-butylene oxide remnant after polymerization; R₂ can be either a hydrogen or another capping group such as an alkyl, C(O)R or benzyl group; and a and b can be the number AO and BO units in the PAG copolymer on average. In one embodiment, the value for a can be zero while the value for b can be greater than zero. The value for c can be a number selected from 1, 2 or 3 and corresponds to the number of hydroxyl groups on the alcohol initiator.

In one embodiment, BO in the BO-containing polyether as described in Structure (I) can be desirably present at a concentration of greater than (>) about 20 wt %, and >about 40 wt % in another embodiment. The molecular weight of the BO-containing polyether foam control agent may be from about 300 to about 2,000 in one general embodiment.

One embodiment of the present invention includes wherein AO in the above Structure (I) is propylene oxide. Thus, the BO-containing polyether foam control agent of the present invention can be formed containing a mixture of oxide units including for example a mixture of propylene oxide (PO) units and butylene oxide (BO) units; and can be described by the following chemical formula designated as Structure (II):

R₁[O-(PO)ₐ-(BO)_{b}-R₂]_{c} Structure (II)

wherein R₁, R₂, a, b, and c can be the same as described with reference to Structure (I).

In another embodiment, the BO-containing polyether foam control agent can be formed containing a mixture of oxide units including for example a mixture of ethylene oxide (EO) units and butylene oxide (BO) units. The resulting polyether with EO/BO units is useful as a foam control agent for agrochemical formulations. For example, the mixed EO/BO polyether of the present invention useful as a foam control agent can be described by the following chemical formula designated as Structure (III):

R₁[O-(EO)ₐ-(BO)_{b}-R₂]_{c} Structure (III)

wherein R₁, R₂, a, b, and c can be the same as described with reference to Structure (I).

The polyether foam control agent product of the present invention may include commercially available products for example the products under the tradename UCON™ OSP available from The Dow Chemical Company. In some preferred embodiments, the polyether foam control agent product of the present invention may include commercially available products such as UCON™ OSP-18, UCON™ OSP-32, UCON™ OSP-46 and UCON™ OSP-68 available from The Dow Chemical Company.

The polyether foam control agent can be added to various pesticide formulations. For example, the polyether foam control agent can be added to a water-based pesticide formulation, such as a soluble liquid (SL) or a microemulsion (ME).

The polyether foam control agent can be mixed with various activators and inert adjuvants, including for example nonionic emulsifiers, anionic emulsifiers, wetting agents, dispersants, and mixtures thereof. The polyether foam control agent can also be mixed with other types of foam control agents, including for example, silica particles, organosilicone, fatty acid and mixtures thereof.

The “end cap” for the PAG is the R² group combined with the oxygen of the alkoxy group to which it attaches. For example, when R² is a hydrogen, the PAG is deemed to have a hydroxyl (—OH) end cap. When R² is an alkyl, the PAG has an ether (—OR²) end cap; and when R² is C(O)R, the PAG has an ester (—OC(O)R) end cap.

The alkyl alcohol initiator corresponds to the structure R¹[OH]_{c} where R¹ is the same in the alcohol and PAG structures described above; and c is the same value as c in the PAG structure above. The alkyl alcohol initiator, and therefore R¹, can contain one carbon or more in one embodiment; 1 carbon to about 30 carbons in another embodiment; 6 carbons to about 20 carbons in still another embodiment; 6 carbons to about 12 carbons in yet another embodiment; and 30 carbons or less in even still another embodiment. Some desirable alkyl alcohol initiators (and R¹ groups) contains 6 or more, 8 or more carbons, 10 or more carbons, 12 or more carbons, 14 or more carbons 16 or more carbons, 18 or more carbons, even 20 or more carbons on average over all PAG molecules. The PAG can comprise a combination of PAG molecules, each having R¹ carbon lengths within the scope of these suitable values. R¹ can be linear or branched alkyl where “linear” means that each carbon has only one or two carbons attached to the each carbon; and “branched” means at least one carbon has at least three carbons attached to the at least one carbon. Examples of suitable alkyl alcohol initiators include those selected from dodecanol, 1,2-propylene glycol, and mixtures thereof.

In one embodiment, the BO containing polyether foam control agent of the present invention can be used in a pesticide formulation. In general, the amount of the polyether in the pesticide formulation can be in the range of from about 0.05 wt % to about 5 wt % in one embodiment and from about 0.1 wt % to about 2 wt % in another embodiment.

In general, the process for preparing the BO-containing compound of the present invention includes mixing and reacting the following compounds in a reactor: an initiator, a catalyst and a defoaming agent comprising a blend of oxides such as butylene oxide and another different alkylene oxide such as propylene oxide to form a polymer product. For example, in one preferred embodiment, the process of preparing the BO-containing compound of the present invention includes the steps of: loading an initiator into a reactor vessel followed by adding a catalyst to the reactor; and then, heating the mixture. Thereafter, a mixture of an alkylene oxide such as propylene oxide and 1,2-butylene oxide, (in equal weight ratios), is fed into the reactor and the resultant mixture is allowed to react to form a polymer. After the reaction, any residual catalyst may be removed by filtration, centrifugation or other removal means.

In other embodiments, polymers of different molecular weights can be synthesized by adjusting the ratio of initiator to oxide feed. Some of the polymer foam control agent products produced by the process above can have typical molecular weights of from about 300 g/mol to about 2,000 g/mol.

The BO group-containing polyether of the present invention advantageously is effective as a foam control agent when used in a water-based agrochemical formulation. Generally, the foam control property performance or effect (also referred to as the high efficiency property) of the BO group-containing polyether can be between about 40% and about 99% in one embodiment, between about 60% and about 95% in another embodiment, and between about 80% and about

95% in still another embodiment (the percentages above represent the defoaming efficiency ratio). The foam control property performance of the BO group-containing polyether may be measured by the test of “persistent foam volume” which is carried out according to the procedure described in GB/T 28137-2011 and used in the Examples herein which follows. Briefly, the percentages above mean defoaming efficiency rate. The defoaming efficiency rate is calculated as follows: (1) the foam volume with defoamer is divided by blank foam volume, and (2) 100%—the value from step (1) above.

In addition, the foam control agent of the present invention is soluble in both water and organic solvents. Moreover, the BO group-containing polyether foam control agent of the present invention is compatible to strong electrolytes present in the water-based agrochemical formulation such as formulations that contain pesticide active materials in the materials' salt type form.

The compatibility here means solubility in aqueous or solvent-based systems. It is mentioned because traditional silicone defoamer is not soluble both in water and solvent. In water, the solubility of a BO containing PAG defoamer is generally up to about 1% depending on the chemical structure of the defoamer. In solvent, the BO containing PAG defoamer may be soluble in many solvents, for example, cyclohexanone, polyether, NMP, xylene, toluene and the like; and the solubility can be up to at least about 5% to about 10%.

The beneficial property of compatibility (or solubility) exhibited by the BO group-containing polyether may be up to about 30% in one embodiment, and from about 1% to about 30% in another embodiment. As one illustration of the present invention, the defoamer has good solubility in an aqueous solution, for example a 30% glyphosate salt aqueous solution, at a dosage of up to about 5 wt % in one embodiment, up to 2 wt % in another embodiment and up to about

1 wt % in still another embodiment. Above the 5 wt % concentration, the water solution may turn cloudy; and in some systems even above the 1 wt % concentration can turn the solution cloudy or turbid.

As another illustration of the present invention, the defoamer has good solubility in solvent or solvent/water systems. For solvent or solvent/water systems, the dosage of the defoamer can be, for example, up to about 30 wt % in one embodiment, from 1 wt % to about 30 wt % in another embodiment, and from 1 wt % to about 20 wt % in still another embodiment because the defoamer has better solubility in a solvent. The defoamer has high solubility up to a dosage of about 30 wt % in a solvent-containing system. However, the defoamer dosage may be less than 30 wt %, for example up to 2 wt % because the defoamer has a high defoaming efficiency.

Another beneficial property of the BO group-containing polyether of the present invention is its stability. During thermal storage at a temperature of 54° C., the foam control agent of the present invention is stable and can maintain its foam control effectiveness. The stability property of the BO group-containing polyether may be in the range of from about 90% to about

100% in one embodiment, from about 95% to about 100% in another embodiment, and from about 99% to about 100% in still another embodiment. The stability property (or the “lasting defoaming property”) of the BO group-containing polyether can be determined using the procedure described herein below in the Examples. For instance, the stability ratio herein may be calculated by the defoaming efficiency % after thermal test divided by the original defoaming %.

Other beneficial properties of the BO group-containing polyether of the present invention include for example, (1) the polyether foam control agent of the present invention is not very sensitive to formulations conditions (such as pH, temperature, solvent and the like); and (2) the polyether foam control agent of the present invention does not decompose or lose its de-foaming effectiveness. For example, the defoamer of the present invention is stable in a relatively broad pH, temperature and solvent range, compared to a silicone defoamer of the prior art. For instance, silicone is stable in a solution having a pH of 6-7. In contrast, there is no specific pH requirement for use of the defoamer of the present invention. Also, there is no storage temperature requirement for the defoamer of the present invention. In addition, the defoamer of the present invention does not decompose and/or lose its defoaming effectiveness when used in combination with common polar solvents, such as methanol. And, with the use of the foam control agent of the present invention, there is no need to use “in-can” and “tank-mix” foam control agents to inhibit the development of foaming in agrochemical applications.

One broad embodiment of the present invention includes a water-based agrochemical formulation including a combination of: (a) the polyether foam control agent of the present invention described above; (b) at least one pesticide active: and (c) at least water.

In preparing the water-based agrochemical formulation of the present invention, a first required component (a) is the polyether foam control agent described above; and as illustrated in Structures (I)-(III). Examples of component (a) are described above; and as aforementioned, in one preferred embodiment, the polyether foam control agent can be a BO group-containing polyether.

The concentration of the polyether foam control agent, component (a), in the water-based agrochemical formulation of the present invention, for example, may range generally from about 0.001 wt % to about 5 wt % in one embodiment, from about 0.01 wt % to about 2 wt % in another embodiment, and from about 0.1 wt % to about 1 wt % in still another embodiment, based on the total weight of the components in the agrochemical formulation.

The foam control agent, component (a), provides the agrochemical formulation with several benefits including for example the following benefits: (1) the foam control agent controls foaming up to about 99%; (2) the foam control agent maintains defoaming efficiency during long term storage at room temperature and at thermal storage; and (3) the foam control agent does not influence or adversely affect the appearance and transparency of the formulation.

The at least one pesticide active, component (b), of the present invention can be any conventional pesticide active. For instance, general examples of component (b) may include one or more of herbicides, insecticides, fungicides and the like that can be made into SL formulations, ME formulations, and the like formulations. Examples of active ingredients are glyphosate (and its salts), paraquat, glufosinate, fluoroglycofen, oxyfluorfen, cyhalofop-butyl, fosthiazate, haloxyfop-R-methyl, indoxacarb, emamectin benzoate, abamectin, imidacloprid, fipronil, beta cypermethrin, acetamiprid, propiconazole, tricyclazole difenoconazole, prochloraz, tebuconazole, hexaconazole, tubatoxin, and the like; and mixtures thereof.

The concentration of the active depends on the drug efficacy of the active itself. For example, for some actives, the concentration of the actives may only be at a very low level because high concentrations of such actives may result in phytotoxicity. On the other hand, for some actives, a high concentration may be used when such burning of crops does not occur at high concentrations of active. Also, the concentration of the active may be restricted by the formulation recipe in which the active is added. For instance, for a ME formulation, the active ingredient may be used at a concentration of up to about 50 wt %.

In one embodiment, the concentration of the pesticide active, component (b), of the present invention may range generally from about 0.5 wt % to about 80 wt %, from about 1 wt % to about 60 wt % in another embodiment, and from about 2 wt % to about 40 wt % in still another embodiment, based on the total weight of the components in the agrochemical formulation.

The pesticide active, component (b), provides the agrochemical formulation with several beneficial properties such as for example the capability to control grass, kill insects and/or control bacteria.

Water, component (c), is a diluent used in the agrochemical formulation. Any type of water can be used in the agrochemical formulation of the present invention including tap water, distilled water, dionized water and the like.

The concentration of the water, component (c), added to the agrochemical formulation is sufficient to may make up the difference in total content (up to 100%) of the components of the agrochemical formulation. For example, the water can range generally from about 1 wt % to about 95 wt % in one embodiment, from about 10 wt % to about 90 wt % in another embodiment, and from about 20 wt % to about 70 wt % in still another embodiment, based on the total weight of the components in the agrochemical formulation.

The agrochemical formulation of the present invention may also include other optional components or additives including for example one or more of solvents, pH adjusting agents, anti-freezing agents, activators, thickeners, emulsifiers, microbiological control agents, and mixtures thereof. The optional additive, component (d), may be added to the agrochemical formulation in the appropriate concentration to provide the agrochemical formulation with the additive's intended function or property. For example, a solvent is usually added in a ME or a SL formulation to further dissolve the solids in the formulation and to diluent the formulation.

The concentration of the optional additives added to the agrochemical formulation of the present invention may range generally from 0 wt % to about 50 wt % in one embodiment, from about 5 wt % to about 50 wt % in another embodiment, and from about 10 wt % to about 40 wt % in still another embodiment, based on the total weight of the components in the agrochemical formulation.

In a broad embodiment, the process of preparing the agrochemical formulation of the present invention includes blending or mixing the above components (a) to (d) together to form the agrochemical formulation.

The process and type of equipment used to prepare the agrochemical formulation of the present invention includes blending or mixing of the above components in conventional mixing equipment or vessels known in the art. For example, the preparation of the agrochemical formulation of the present invention is achieved by blending, in known mixing equipment, components (a)-(c) and optionally (d) any other desirable additives. The preparation of the agrochemical formulation of the present invention, and/or any of the steps thereof, may be a batch or a continuous process.

All the above compounds of the agrochemical formulation are typically mixed and dispersed in a vessel at a temperature enabling the preparation of an effective agrochemical formulation. Typically, the components are mixed at room temperature (about 25° C.). In an embodiment where the active ingredient(s) is solid, the solid component can be dissolved in water or solvent at a warmer temperature other than room temperature. For example, the mixture may be warmed at a temperature of from about 40° C. to about 50° C. to speed up the dissolution process. Any other process conditions known in the art can be used in preparing the mixture.

In one preferred embodiment, the process of preparing a SL or ME agrochemical formulation of the present invention includes, for example, the following steps:

Step (1): If solvent is needed, the active ingredient may be firstly dissolved in a solvent under stirring at room temperature until complete dissolution of the ingredient is obtained to form a transparent solution.

Step (2): Component (a) and oil soluble component (d) are mixed with component (b) until complete dissolution is obtained to form a transparent solution.

Step (3): Any water soluble component (d) used in the agrochemical formulation is dissolved in a water phase.

Step (4): Under stirring or homogenizing, e.g. at a range of from about 300 rpm to about 3,000 rpm, component (c) water is added to the mixture obtained above. The resulting mixture is stirred for another 10 min after mixing. Thereafter, a uniform clear solution is generated.

The agrochemical formulation that is prepared by the above process of the present invention exhibits several unexpected and unique properties; and several of the improvements of the BO group-containing polyether foam control agent are imparted to the agrochemical formulation. For example, some of the important properties of the agrochemical formulation containing the BO group-containing polyether foam control agent can include: (1) the agrochemical formulation can have up to 99% foaming control property compared to a blank formulation without the BO group-containing foam control agent, (2) the agrochemical formulation can have a lasting foam control effect during storage, (3) the agrochemical formulation can have no deleterious effect on foam control performance by pH, solvent or temperature; and (4) the foam control agent, present in the agrochemical formulation, does not influence or adversely affect the appearance and transparency of the agrochemical formulation.

Generally, the foam control efficiency performance property of the agrochemical formulation can be between about 40% and about 99% in one embodiment, between about 60% and about 95% in another embodiment, and between about 80% and about 95% in still another embodiment. The foam control performance property of the agrochemical formulation may be measured by the procedure described in GB/T 28137-2011.

Another beneficial property of the agrochemical formulation of the present invention is its lasting foam control effect during thermal storage, e. g. 54° C. The foam control efficiency during thermal storage property of the agrochemical formulation may be in the range of from about 90% to about 100% in one embodiment, from about 95% to about 100% in another embodiment, and from about 99% to about 100% in still another embodiment. The foam control effect property of the agrochemical formulation can be determined using the procedure as described in GB/T 28137-2011.

Because of the beneficial properties exhibited by the BO group-containing polyether foam control agent and the agrochemical formulation, the agrochemical formulation of the present invention is advantageously used in agrochemical applications including for example herbicides, insecticides, fungicides, and the like.

### EXAMPLES

The following Examples and Comparative Examples further illustrate the present invention in more detail but are not to be construed to limit the scope thereof.

In the following Examples and Comparative Examples, various terms and designations were used and are explained as follows:

“SL” stands for soluble liquid.

“ME” stands for microemulsion.

UCON™ OSP-18, UCON™ OSP-32, UCON™ OSP-46, and UCON™ OSP-68 are various product grades for UCON™ OSP products commercially available from The Dow Chemical Company.

### General Procedure for the Preparation of SL Formulation

In a SL formulation, active ingredients are completely dissolved in either (i) water miscible polar solvents or (ii) water. Thus, the preparation process for preparing a SL formulation is very simple: mix the active ingredient with surfactants, water or solvent under stirring. The surfactants in SL are mainly for application purpose to lower surface tension and improve spreading performance.

### General Procedure for the Preparation of ME Formulation

A ME usually comprises of active ingredient, solvent, co-solvent, emulsifier and water. Active ingredient is firstly dissolved in solvents to form a uniform oil phase. Heating may be used to speed up the dissolution process. Then a certain amount of emulsifiers and water are mixed with the oil phase under stirring. Since a ME is a thermodynamic stable system, it has been found that the preparation process of the ME has very little influence on formulation appearance and performance.

The components used in preparing the SL and ME formulations are listed in Table I:

TABLE I

| Component | Component Description | Supplier |
|---|---|---|
| glyphosate | N-(phosphonomethyl)glycine | Wynca |
| haloxyfop-R-methyl | (R)-2-[4-(3-chloro-5-trifluoromethyl- | Sanlen |
| | 2-pyridyloxy)phenoxy]propionic acid | |
| fosthiazate | (RS)-S-sec-butyl-O-ethyl-2-oxo-1,3- | Sanlen |
| | thiazolodin-3-ylphosphonothioate | |
| TRITON ™ CG-110 | alkyl polyglycoside | The Dow Chemical |
| | | Company |
| cyclohexanone | cyclohexanone | Sinopharm Chemical |
| | | Reagent |
| Butyl | diethylene glycol n-Butyl Ether | The Dow Chemical |
| CARBITOL ™ | | Company |
| ECOSURF ™ EH-3 | iso-octanol alkoxylates | The Dow Chemical |
| | | Company |
| DOWFAX ™ D-800 | EO/PO polyethers | The Dow Chemical |
| | | Company |
| TRITON ™ GR-7M | alkyl sodium sulfosuccinate | The Dow Chemical |
| | | Company |
| DOWFAX ™ 2A1 | disodium branched dodecyl | The Dow Chemical |
| | diphenoloxide disulfonate | Company |
| ECOSURF ™ EH-14 | iso-octanol alkoxylates | The Dow Chemical |
| | | Company |

### General Method of Preparing Standard Hard Water

The method of preparing standard hard water includes dissolving anhydrous calcium chloride (0.304 grams (g)) and magnesium chloride hexahydrate (0.139 g) in deionized (DI) water and then diluting the mixture to scale in a 1,000 milliliter (mL) volumetric flask.

In the Examples and Comparative Examples, the following standard measurements, analytical equipment, and test methods are used:

### Persistent Foam Volume Test Measurements

The test of “persistent foam volume” is carried out according to the procedure described in GB/T 28137-2011 which can be summarized in the following general steps:

Step (1): Weigh about 180 g standard water (342 part per million (ppm)) into a 250 mL graduated cylinder with a glass stopple. The distance between the 0 mark and the 250 mark of the cylinder is 20-21.5 centimeters (cm), and the distance between 250 mL mark of the cylinder and the bottom of the stopple is 4-6 cm.

Step (2): Add 1.0 g of the pesticide formulation sample into the water.

Step (3): Add standard water (342 ppm) into the cylinder until the distance between the surface of the solution in the cylinder and the bottom of the stopple is 9 cm.

Step (4): Place a stopple on the cylinder to seal the cylinder; and invert the cylinder 30 times within 1 minute (min) (which is about 2 seconds (s) for one complete inversion cycle).

Step (5): After step (4), place the cylinder upright on a laboratory bench and immediately start a stopwatch to measure the time foaming begins. Read and record the foam volume after 1 min.

Several liquid polyethers defoamer products can be used to lower the foam volume of various solutions. All the polyether defoamer products listed in Table II are commercially available from The Dow Chemical Company. The chemical description of each of the polyethers is also described in the Table II.

TABLE II

| Polyether | Chemical Description |
|---|---|
| DOWFAX ™ 25A414 | alkyl alcohol EO/PO copolymer |
| DOWFAX ™ 141 | n-butanol EO/PO reversed copolymer |
| DOWFAX ™ 103 | glycerin EO/PO reverse copolymer |
| POLYGLYCOL P 1000E | polypropylene glycol |
| POLYGLYCOL P 2000E | polypropylene glycol |
| POLYGLYCOL P 4000E | polypropylene glycol |
| UCON ™ OSP-18 | C12 PO/BO random copolymer |
| UCON ™ OSP-68 | C12 PO/BO random copolymer |

### Examples 1-2 and Comparative Examples A-G

In these Examples, formulations were prepared by mixing the components or ingredients described in Table III. The glyphosate IPA active ingredient was firstly prepared by neutralizing glyphosate with isopropanol amine (IPA) to form glyphosate IPA. Then the ingredients: glyphosate IPA active ingredient, surfactant, foam control agent and water were mixed under mechanical agitation to prepare a SL formulation. The concentration of glyphosate IPA is calculated based on glyphosate acid weight.

### Foam Control Performance in 30 wt % Glyphosate SL

The Examples described in Table III were tested using the persistent foam volume method which was carried out according to the procedure described in GB/T 28137-2011. The foam volume in a blank test (Comparative Example A) is 65 mL.

TABLE III

| | Comparative | | | | | | | | |
|---|---|---|---|---|---|---|---|---|---|
| | Example A | | | | | | | | |
| | (Blank - | | | Comparative | Comparative | Comparative | Comparative | Comparative | Comparative |
| Component | no defoamer) | Example 1 | Example 2 | Example B | Example C | Example D | Example E | Example F | Example G |
| glyphosate IPA | 30 wt % | 30 wt % | 30 wt % | 30 wt % | 30 wt % | 30 wt % | 30 wt % | 30 wt % | 30 wt % |
| (wt % based on | | | | | | | | | |
| glyphosate) | | | | | | | | | |
| TRITON ™ | 10 wt % | 10 wt % | 10 wt % | 10 wt % | 10 wt % | 10 wt % | 10 wt % | 10 wt % | 10 wt % |
| CG-110 | | | | | | | | | |
| UCON ™ OSP-18 | | 0.2 wt % | 0.5 wt % | | | | | | |
| POLYGLYCOL | | | | 0.2 wt % | | | | | |
| P-4000 | | | | | | | | | |
| POLYGLYCOL | | | | | 0.2 wt % | 0.3 wt % | | | |
| P-2000 | | | | | | | | | |
| DOWFAX ™ | | | | | | | 0.2 wt % | | |
| DF-103 | | | | | | | | | |
| DOWFAX ™ 25A414 | | | | | | | | 0.2 wt % | |
| DOWFAX ™ DF141 | | | | | | | | | 0.2 wt % |
| water | to 100% | to 100% | to 100% | to 100% | to 100% | to 100% | to 100% | to 100% | to 100% |
| Foam volume, ml | 65 | 10 | 3 | Turbid | 20 | Turbid | 25 | 35 | 35 |

As shown by the results in Table III, all the polyether foam control agents at 0.2 wt % dosage helped in lowering the foam volume of the formulations tested. However, PO/BO-based UCON™ OSP-18 foam control agent (Example 1) showed the best defoaming effectiveness compared to either a PO-based foam control agent (Comparative Examples B and C) and a EO/PO-based foam control agent (Examples D and F). Moreover, the PO/BO-based UCON™ OSP-18 foam control agent (Example 2) at 0.5 wt % dosage has an increased compatibility and maintains the formulation as a clear liquid in appearance. In contrast, a POLYGLYCOL P-4000 foam control agent (Comparative Example B) causes turbidity at a dosage of 0.2 wt %, and the POLYGLYCOL P-2000 foam control agent (Comparative Example D) was insoluble at 0.3% dosage.

### Examples 3 and 4 and Comparative Examples H-K

In these Examples, formulations were prepared by mixing the components or ingredients described in Table IV. The haloxyfop-R-methyl active ingredient of Table IV was firstly dissolved in solvents to form a uniform oil phase. Heating may be applied to the haloxyfop-R-methyl and the solvent mixture to speed up the dissolution process. Then, an amount of emulsifiers, foam control agent and water as described in the Examples of Table IV were added to the oil phase. And, the final product was formed under stirring of the ingredients mixed in the oil phase.

### Foam Control Performance in ME

The Examples described in Table IV were tested using the persistent foam volume method which was carried out according to the procedure described in GB/T 28137-2011. The foam volume in a blank test (Comparative Example H) is 65 mL.

TABLE IV

| | Comparative | | | | | |
|---|---|---|---|---|---|---|
| | Example H | | | | | |
| | (Blank - no | | | Comparative | Comparative | Comparative |
| Component | defoamer) | Example 3 | Example 4 | Example I | Example J | Example K |
| haloxyfop-R-methyl | 17 wt % | 17 wt % | 17 wt % | 17 wt % | 17 wt % | 17 wt % |
| cyclohexanone | 10 wt % | 10 wt % | 10 wt % | 10 wt % | 10 wt % | 10 wt % |
| Butyl CARBITOL ™ | 15 wt % | 15 wt % | 15 wt % | 15 wt % | 15 wt % | 15 wt % |
| ECOSURF ™ EH-3 | 8 wt % | 8 wt % | 8 wt % | 8 wt % | 8 wt % | 8 wt % |
| DOWFAX ™ D-800 | 8 wt % | 8 wt % | 8 wt % | 8 wt % | 8 wt % | 8 wt % |
| TRITON ™ GR-7M | 5 wt % | 5 wt % | 5 wt % | 5 wt % | 5 wt % | 5 wt % |
| UCON ™ OSP-18 | | 2 wt % | | | | |
| UCON ™ OSP-68 | | | 2 wt % | | | |
| POLYGLYCOL | | | | 2 wt % | | |
| P-2000 | | | | | | |
| DOWFAX ™ | | | | | 2 wt % | |
| DF-103 | | | | | | |
| DOWFAX ™ | | | | | | 2 wt % |
| 25A414 | | | | | | |
| water | to 100% | to 100% | to 100% | to 100% | to 100% | to 100% |
| Foam volume, ml | 65 | 10 | 15 | 30 | 30 | 35 |

As shown by the results in Table IV, the experimental results of the foaming tests performed in the above ME formulations indicate that the PO/BO-based UCON™ OSP-18 and UCON™ OSP-68 foam control agent (Examples 3 and 4, respectively) exhibited high foam control effectiveness compared with the PO-based polyether foam control agent (Comparative Example I) and the EO/PO-based polyether foam control agent (Comparative Examples J and K).

### Example 5 and Comparative Examples L-O

In these Examples, formulations were prepared by mixing the components or ingredients described in Table V. The formulations of the Examples were obtained by mixing the ingredients: fosthiazate, butyl CARBITOL™ solvent, DOWFAX™ 2 A1 and ECOSURF™ EH-14 surfactants under agitation until a clear solution was generated.

### Foam Control Performance in ME

The Examples described in Table V were tested using the persistent foam volume method which was carried out according to the procedure described in GB/T 28137-2011. The foam volume in a blank test (Comparative Example L) is 65 mL.

TABLE V
5 wt % Fosthiazate ME

| | Comparative | | | | |
|---|---|---|---|---|---|
| | Example L | | | | |
| | (Blank - no | | Comparative | Comparative | Comparative |
| Component | defoamer) | Example 5 | Example M | Example N | Example O |
| fosthiazate | 5 wt % | 5 wt % | 5 wt % | 5 wt % | 5 wt % |
| Butyl CARBITOL ™ | 10 wt % | 10 wt % | 10 wt % | 10 wt % | 10 wt % |
| DOWFAX ™ 2A1 | 2 wt % | 2 wt % | 2 wt % | 2 wt % | 2 wt % |
| ECOSURF ™ EH-14 | 8 wt % | 8 wt % | 8 wt % | 8 wt % | 8 wt % |
| UCON ™ OSP-18 | | 1 wt % | | | |
| POLYGLYCOL | | | 1 wt % | | |
| P-2000 | | | | | |
| DOWFAX ™ | | | | 1 wt % | |
| DF-103 | | | | | |
| DOWFAX ™ | | | | | 1 wt % |
| 25A414 | | | | | |
| water | to 100% | to 100% | to 100% | to 100% | to 100% |
| Foam volume, ml | 65 | 15 | 40 | 45 | 45 |

The experimental results from the foaming tests performed in the above two ME formulations described in Table V indicate that the PO/BO-based UCON™ OSP-18 foam control agent (Example 5) exhibited better foam control effectiveness compared with the PO-based polyether foam control agent (Comparative Example M) and the EO/PO-based polyether foam control agent (Comparative Examples N and O).

The sample formulation of Example 5 was placed in an oven at 54° C. for one week. Almost no significant change of foam volume for the formulation of Example 5 was observed after the storage at the elevated temperature of 54° C.

Based on the experimental results as described above, the present invention provides (1) a BO-containing polyether foam control agent which can be effective in water-based agrochemical formulations; (2) a BO-containing polyether foam control agent that performs as good or better than traditional EO/PO or PO based polyether foam control agents; and (3) a

BO-containing polyether foam control agent such as a PO/BO-based foam control agent that is compatible with high electrolyte active ingredients.

1. A polyether foam control agent comprising a butylene-containing polyether foam control agent having the following chemical formula:
R₁[O-(AO)ₐ-(BO)_{b}-R₂]_{c} Structure (I)
wherein R₁ can be an alkyl backbone remnant from an alkyl alcohol initiator with carbon atoms of from 1 to about 30; AO can be a propylene oxide or an ethylene oxide remnant after copolymerization; BO can be a 1,2-butylene oxide remnant after polymerization; R₂ can be either a hydrogen or another capping group such as an alkyl with carbon atoms of from 1 to about 10, C(O)R or a benzyl group; R can be alkyl carbon chain with carbon atoms of from 1 to about 10; a can be an average number of from zero to 30; b can be an average number of greater than zero to 30; and c can be a number selected from 1, 2 or 3 and corresponds to the number of hydroxyl groups on the alcohol initiator.

2. The polyether foam control agent of claim 1, wherein AO is propylene oxide units.

3. The polyether foam control agent of claim 1, wherein AO is ethylene oxide units.

4. The polyether foam control agent of claim 1, wherein the concentration of the BO in the polyether is greater than about 20 weight percent.

5. The polyether foam control agent of claim 1, wherein the molecular weight of the BO-containing polyether foam control agent is from about 300 to about 2,000.

6. The polyether foam control agent of claim 1, wherein the polyether foam control agent product is a propylene oxide/butylene oxide polyether with 1:1 ratio based on weight.

7. The polyether foam control agent of claim 1, wherein the polyether foam control agent exhibits a defoaming effectiveness property or efficiency in the range of from about
80 percent to about 95 percent.

8. The polyether foam control agent of claim 1, wherein the polyether foam control agent is compatible with strong electrolytes present in the water-based agrochemical formulation when the electrolyte concentration in solution is from about 0.1 weight percent to about 40 weight percent.

9. An agrochemical formulation comprising:
(a) at least one polyether foam control agent of claim 1;
(b) at least one pesticide active; and
(c) water.

10. The formulation of claim 9, including (d) at least one additive selected from the group consisting of solvent, emulsifier, anti-freezing agent, thickener, microbiologic control agent, and mixtures thereof.

11. The formulation of claim 9, wherein the at least one pesticide active is a glyphosate, a glufosinate, or mixtures thereof.

12. The formulation of claim 9, wherein the concentration of the at least one polyether foam control agent is in the range of from about 0.01 weight percent to about 5 weight percent.

13. The formulation of claim 9, wherein the concentration of the at least one pesticide active is in the range of from about 0.5 weight percent to about 80 weight percent.

14. The formulation of claim 9, wherein the formulation is selected from the group consisting of a soluble liquid, a microemulsion, an emulsion-in water, and mixtures thereof.

15. The formulation of claim 9, wherein formulation is stable under storage at a temperature in the range of from about 0° C. to less than about 60° C.

16. A process for preparing an agrochemical formulation comprising admixing:
(a) at least one polyether foam control agent of claim 1;
(b) at least one pesticide active; and
(c) water.
